(19) United States
(12) Patent Application Publication
(10) Pub. No.: US 2026/0010833 A1
(43) Pub. Date: Jan. 8, 2026

(54) MODEL FUSION METHOD, ELECTRONIC DEVICE AND STORAGE MEDIUM

(71) Applicant: BEIJING BAIDU NETCOM SCIENCE TECHNOLOGY CO., LTD., Beijing (CN)

(72) Inventors: Ziyang Xu, Beijing (CN); Xuyi Chen, Beijing (CN); Bo Ke, Beijing (CN); Zhengjie Huang, Beijing (CN); Shikun Feng, Beijing (CN); Shiwei Huang, Beijing (CN)

(73) Assignee: BEIJING BAIDU NETCOM SCIENCE TECHNOLOGY CO., LTD., Beijing (CN)

(21) Appl. No.: 19/325,304

(22) Filed: Sep. 10, 2025

(30) Foreign Application Priority Data
Jun. 16, 2025 (CN) 2025108064372

(51) Int. Cl. G06N 20/00

(52) U.S. Cl. CPC G06N 20/00

(57) ABSTRACT

A model fusion method includes: calling a main process during a pre-training process of a large model, to cache intermediate model parameters obtained during the pre-training process into a main buffer; and calling a sub-process via the main process to read the intermediate model parameters from the main buffer and perform a parameter fusion process based on the intermediate model parameters.

### CROSS-REFERENCE TO RELATED APPLICATIONS

The present application is based on and claims the priority of Chinese patent application No. 2025108064372 filed on Jun. 16, 2025, the entire contents of which are incorporated herein by reference.

### TECHNICAL FIELD

The disclosure relates to the technical field of artificial intelligence, such as deep learning, cloud computing, large model and the like, in particular to a model fusion method, a model fusion apparatus and an electronic device.

### BACKGROUND

Currently, during a pre-training process of a large model, in order to improve a performance of the pre-trained large model, model parameters obtained during each training cycle in the pre-training process of the large model can be fused.

The primary fusion method used is online fusion. In online fusion, the pre-training of the large model is interleaved with the fusion of the intermediate model parameters obtained in training, which reduces the efficiency of the pre-training of the large model.

### SUMMARY

The disclosure provides a model fusion method, a model fusion apparatus and an electronic device.

According to a first aspect of the disclosure, a model fusion method is provided. The method includes: calling a main process during a pre-training process of a large model, to cache intermediate model parameters obtained during the pre-training process into a main buffer; and calling a sub-process via the main process to read the intermediate model parameters from the main buffer and perform a parameter fusion process based on the intermediate model parameters.

According to a second aspect of the disclosure, an electronic device is provided. The electronic device includes: at least one processor and a memory communicatively connected to the at least one processor. The memory stores an instruction executable by the at least one processor, and the instruction, when being executed by the at least one processor, enables the at least one processor to implement the above model fusion method in the disclosure.

According to a third aspect of the disclosure, a non-transitory computer-readable storage medium is provided. The medium includes a computer instruction, and the computer instruction is used for causing a computer to implement the above model fusion method in the disclosure.

According to a fourth aspect of the disclosure, a computer program product is provided. The product includes a computer program, when being executed by a processor, implements the steps of the above model fusion method in the disclosure.

It should be understood that what is described in this section is not intended to identify key or important features of the embodiments of the disclosure, nor is it intended to limit the scope of the disclosure. Other features of the disclosure will be readily understood from the following description.

### BRIEF DESCRIPTION OF THE DRAWINGS

The accompanying drawings are for better understanding the solution and do not constitute as a limitation on the disclosure, in which:

FIG. 1 is a schematic diagram according to a first embodiment of the disclosure.

FIG. 2 is a schematic diagram according to a second embodiment of the disclosure.

FIG. 3 is a schematic diagram according to a third embodiment of the disclosure.

FIG. 4 is a schematic diagram illustrating a framework of a main process and a sub-process.

FIG. 5 is a schematic diagram illustrating an execution of the main process and the sub-process.

FIG. 6 is a schematic diagram according to a fourth embodiment of the disclosure.

FIG. 7 is a block diagram of an electronic device that is used for implementing the model fusion method of the embodiment of the disclosure.

### DETAILED DESCRIPTION

Example embodiments of the disclosure are described below in combination with the accompanying drawings, in which various details of the embodiments of the disclosure are included to facilitate understanding, and they should be considered as exemplary only. Therefore, those skilled in the art should realize that various changes and modifications can be made to the embodiments described herein without departing from the scope and spirit of the disclosure. For clarity and brief, descriptions of well-known functions and structures are omitted in the following descriptions.

Currently, during a pre-training process of a large model, in order to improve a performance of the pre-trained large model, model parameters obtained during each training cycle in the pre-training process of the large model can be refused.

The primary fusion mode used is online fusion. In online fusion, the pre-training of the large model is interleaved with the fusion of the intermediate model parameters obtained in training are, which reduces the efficiency of the pre-training of the large model.

To solve the above problems, the disclosure provides a model fusion method, a model fusion apparatus and an electronic device.

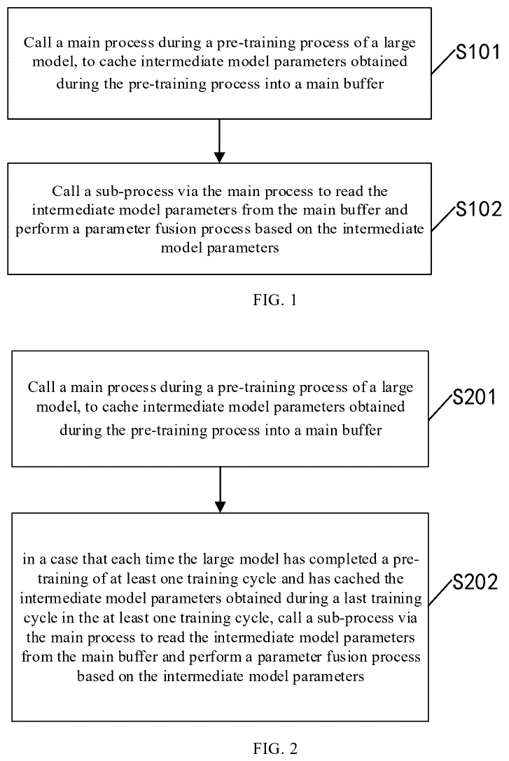

FIG. 1 is a schematic diagram according to a first embodiment of the disclosure. It should be noted that a model fusion method of the embodiment of the disclosure can be applied to a model fusion apparatus, which is configured in an electronic device to enable the electronic device to execute a model fusion function.

The electronic device may be any device having a computing capability, such as a personal computer (PC), a mobile terminal, a server, a cluster, etc. The mobile terminal may be, for example, a vehicle-mounted device, a mobile phone, a tablet computer, a personal digital assistant, a wearable device, a smart speaker, a server, a server cluster and other hardware devices with various operating systems, touch screens and/or displays.

The model fusion apparatus may also be software in the electronic device, such as model fusion software. An example of an execution subject being the electronic device is given in the following embodiments.

As illustrated in FIG. 1, the model fusion method includes the following steps.

At step 101, a main process is called during a pre-training process of a large model, to cache intermediate model parameters obtained during the pre-training process into a main buffer.

In an embodiment of the disclosure, there is one main process, the intermediate model parameters stored in the main buffer corresponding to the main process are the entire model parameters of the large model. Correspondingly, there is one sub-process. The main process acts as a caller, and the sub-process acts as a callee. That is, the main process may call the sub-process, and the sub-process is being called by the main process.

In the embodiments of the disclosure, the main process includes a plurality of main processes. The intermediate model parameters stored in main buffers corresponding to the plurality of main processes respectively are respective parts of model parameters of the large model. Correspondingly, the sub-process comprises a plurality of sub-processes. The plurality of main processes are in a one-to-one correspondence with the plurality of sub-processes. The main process still acts as a caller, and the sub-process acts as a callee.

The main buffers corresponding to the plurality of main processes may be located in different graphics processing units (GPUs), so that the pre-training process of the large model is implemented with a plurality of GPUs.

The configuration of the plurality of main processes and the plurality of corresponding sub-processes enables distributed pre-training of the large model, thereby increasing the pre-training speed and reducing the duration of pre-training.

In the embodiments of the disclosure, there are a plurality of training cycles during the pre-training process of the large model. In each training cycle, the main process is called to cache the intermediate model parameters obtained in training into the main buffer. While caching, the previous intermediate model parameters cached in the main buffer can be overwritten, so as to update the intermediate model parameters in the main buffer.

It should be noted that the intermediate model parameters in step 101 may be model parameters obtained during any training cycle. For example, it may be model parameters obtained during a first training cycle or model parameters obtained during a last training cycle.

In the embodiments of the disclosure, in a case that the large model is a mixed-precision large model, meaning the model parameters of the large model include parameters of at least two precisions (e.g., 16-bit floating-point, 32-bit floating-point, etc.), the number of main buffers in a main process may be at least two. Correspondingly, the number of sub-buffers in the sub-processes corresponding to the main process may also be at least two.

In an example, in a main process, the number of main buffers may be consistent with the number of precisions of floating points in the large model. That is, the floating point with the highest bit is stored in a main buffer, and floating points with each of other bits are converted into the floating points with the highest bit and stored in a main buffer, respectively.

In another example, in a main process, there are two main buffers. That is, the floating points with the highest bit is stored in one main buffer, and floating points with other bits are converted into the floating points with the highest bit and stored in the other main buffer.

At step 102, a sub-process is called via the main process to read the intermediate model parameters from the main buffer and perform a parameter fusion process based on the intermediate model parameters.

In the embodiments of the disclosure, in order to support the sub-process to directly read the intermediate model parameters from the main buffer and to improve the efficiency of reading the intermediate model parameters, the sub-process may access the main buffer through an inter-process communication (IPC) mechanism to obtain the intermediate model parameters from the main buffer, and then store the intermediate model parameters in a sub-buffer.

IPC mechanism is, for example, a compute unified device architecture (CUDA) IPC mechanism, which is used for assisting the sub-process in accessing the main buffer in the main process to read the intermediate model parameters from the main buffer.

In the embodiments of the disclosure, the sub-buffer is a high-speed memory in a central processing unit (CPU), and the main buffer is a memory in a GPU. Data exchange between the memory in the GPU and the high-rate memory in the CPU is faster, which can further improve the efficiency of reading the intermediate model parameters by the sub-process.

The asynchronous execution of the main process and the sub-process, coupled with the use of high-speed memory for the sub-buffer and GPU memory for the main buffer, enables the sub-process to rapidly read the main buffer in the main process. This capability allows the sub-process to perform multiple read operation on the main buffer, facilitating the fusion of intermediate model parameters from a larger number of training cycles. As a result, the model fusion efficiency is significantly improved, further enhancing the accuracy of the fused model.

In the model fusion method of the embodiments of the disclosure, the main process is called during the pre-training process of the large model to cache the intermediate model parameters during the pre-training process to the main buffer. The main process calls the sub-process to read the intermediate model parameters from the main buffer and perform the parameter fusion process based on the intermediate model parameters. The main process and the sub-process can operate asynchronously, enabling simultaneous pre-training of the large model and parameter fusion of the intermediate model parameters obtained during the pre-training process of the large model. This approach improves the efficiency of model fusion without affecting the pre-training efficiency of the large model.

In order to improve the accuracy of the intermediate model parameters read by the sub-process, prevent simultaneous reading of intermediate model parameters from two different training cycles, and reduce the error rate in reading intermediate model parameters, the sub-process may be called to read the intermediate model parameters only after the large model has completed one training cycle and has cached the intermediate model parameters obtained during the one training cycle. As illustrated in FIG. 2, FIG. 2 is a schematic diagram according to a second embodiment of the disclosure. The embodiment shown in FIG. 2 includes the following steps.

At step 201, a main process is called during a pre-training process of a large model, to cache intermediate model parameters obtained during the pre-training process into a main buffer.

At step 202, each time the large model has completed a pre-training of at least one training cycle and has cached intermediate model parameters obtained during a last training cycle in the at least one training cycle, a sub-process is called via the main process to read the intermediate model parameters from the main buffer and perform a parameter fusion process based on the intermediate model parameters.

In the embodiments of the disclosure, in an example, in a case that each time the large model completes the pre-training of one training cycle and caches the intermediate model parameters obtained during the one training cycle, the sub-process is called via the main process to read the intermediate model parameters from the main buffer and perform the parameter fusion process based on the intermediate model parameters.

In another example, in a case that the large model has completed the pre-training of a plurality of training cycles and has cached the intermediate model parameters obtained during a last training cycle in the plurality of training cycles, the sub-process is called via the main process to read the intermediate model parameters from the main buffer and perform the parameter fusion process based on the intermediate model parameters.

In the embodiments of the disclosure, in order to prevent the main process from caching new intermediate model parameters into the main buffer when the sub-process is still reading the intermediate model parameters, the electronic device may determine a duration of the training cycle and set the duration to be greater than or equal to a duration required for the sub-process to read the intermediate model parameters from the main buffer. Or, the electronic device may set the duration required for the sub-process to read the intermediate model parameters from the main buffer to be less than or equal to the duration of the training cycle.

In the embodiment of the disclosure, a number of training cycles in the at least one training cycle is determined based on a sum of a duration required for the sub-process to read the intermediate model parameters and a duration required for performing the parameter fusion process based on the intermediate model parameters.

The duration required for the sub-process to read the intermediate model parameters refers to a duration from a moment when the sub-process starts to read the intermediate model parameters to a moment when the reading is completed. The duration required for performing the parameter fusion process based on the intermediate model parameters refers to a duration from a moment when the sub-process starts to perform the parameter fusion process to a moment when the parameter fusion process is completed.

The electronic device obtains a sum of a duration of a training cycle and a duration for caching the intermediate model parameters into the main buffer, which is taken as a first sum. It also obtains a sum of the duration required for the sub-process to read the intermediate model parameters and the duration required for the sub-process to perform the parameter fusion process based on the intermediate model parameters, which is taken as a second sum. It determines a quotient and a remainder of the second sum and the first sum, and determines a sum of the quotient and 1 as a minimum number of training cycles in the at least one training cycle.

The number of training cycles in the at least one training cycle is determined based on the sum of the duration required for the sub-process to read the intermediate model parameters and the duration required for the sub-process to perform the parameter fusion process based on the intermediate model parameters. This determines a minimum interval between training cycles at which the sub-process can read the intermediate model parameters. Based on the interval, the intermediate model parameters are read and fused, enabling the fusion of intermediate model parameters from a larger number of training cycles. This facilitates high-frequency model fusion, further enhancing fusion efficiency and ultimately improving the accuracy of the fused model.

In the embodiments of the disclosure, in order to further improve the accuracy of the fused model parameter obtained after the fusion process, the method for parameter fusion processing by the sub-process based on the intermediate model parameters includes: reading historical fused model parameters from a fusing sub-buffer, in which the historical fused model parameters are determined by fusing historical intermediate model parameters obtained during at least two training cycles in the pre-training process of the large model; obtaining current fused model parameters by fusing the intermediate model parameters and the historical fused model parameters; and storing the current fused model parameters into the fusing sub-buffer.

The sub-process performs fusion process on the intermediate model parameters and the historical fused model parameters to obtain the current fused model parameters. The process may include: determining a first weight for the intermediate model parameters and a second weight for the historical fused model parameters; and obtaining the current fused model parameters by weighting and summing the intermediate model parameters and the historical fused model parameters based on the first weight and the second weight.

Considering that the historical fused model parameters may be obtained by fusing the intermediate model parameters of many training cycles, different weights are set for the intermediate model parameters and the historical fused model parameters, which improves the accuracy of the current fused model parameter obtained after the fusion process.

For each parameter of the intermediate model parameters, the sub-process may determine a fused parameter of the historical fused model parameters corresponding to the each parameter, and obtain a fused parameter by weighting and summing the parameter and the fused parameter based on the first weight and the second weight.

It should be noted that the fusion processes of respective parameters of the intermediate model parameters are independent and do not affect each other. The sub-process may perform the fusion processes of respective parameters of the intermediate model parameters in parallel, which improves the model fusion efficiency.

It should be noted that the details of step 201 can refer to that of step 101 in the embodiment shown in FIG. 1, which will not be described in detail here.

In the model fusion method of the embodiments of the disclosure, the main process is called during the pre-training process of the large model to cache the intermediate model parameters obtained during the pre-training process into the main buffer. In the case that the large model has completed the pre-training process of at least one training cycle and has cached the intermediate model parameters obtained during all the at least one training cycle, it calls the sub-process by the main process to read the intermediate model parameters from the main buffer and perform the parameter fusion process based on the intermediate model parameters. If the large model has completed one training cycle and has cached the intermediate model parameter obtained during the one training cycle, it calls the sub-process to read the intermediate model parameters, which can avoid reading the intermediate model parameters obtained during two different training cycles simultaneously, thereby improving the accuracy of the intermediate model parameter read by the sub-process.

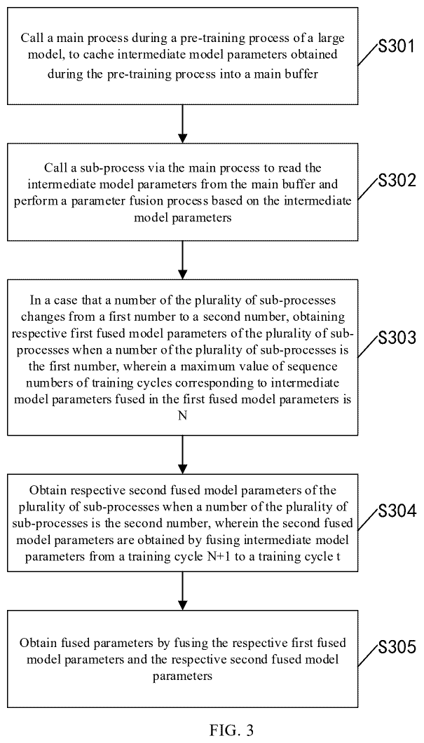

In a case that a number of the plurality of sub-processes changes from a first number to a second number, the intermediate model parameters stored in the sub-buffer of each sub-process also change. For example, when the number changes, the sequence number of the stored intermediate model parameter changes. In order to avoid the need for re-pre-training of the large model and avoid the impact on pre-training efficiency of the large model, the fused model parameters of each sub-processes when the number of the plurality of sub-processes is the first number and the fused model parameters of each sub-processes when the number of the plurality of sub-processes is the second number can be fusion processed. As illustrated in FIG. 3, FIG. 3 is a schematic diagram according to a third embodiment of the disclosure. The embodiment shown in FIG. 3 includes the following steps.

At step 301, a main process is called during a pre-training process of a large model, to cache an intermediate model parameters obtained during the pre-training process into a main buffer.

At step 302, a sub-process is called via the main process to read the intermediate model parameters from the main buffer and perform a parameter fusion process based on the intermediate model parameters.

At step 303, in a case that a number of the plurality of sub-processes changes from a first number to a second number, respective first fused model parameters of the plurality of sub-processes are obtained when a number of the plurality of sub-processes is the first number, in which a maximum value of sequence numbers of training cycles corresponding to intermediate model parameters fused in the first fused model parameters is N.

In the embodiments of the disclosure, the sub-processes are in one-to-one correspondence with the main processes. In a case that the number of sub-processes changes from the first number to the second number, the number of main processes also changes from the first number to the second number. Since the main buffers corresponding to the main processes may be located in different GPUs, the number of GPUs during the pre-training process of the large model also changes, that is, the number of GPUs may increase or decrease during the pre-training process of the large model. That is, the number of GPUs may increase, or the number of GPUs may decrease. In such case, the number of sub-processes also changes.

The maximum value of the sequence numbers of training cycles corresponding to the intermediate model parameter fused in the first fused model parameters is N, indicating that the latest parameter fusion process is the fusion process of the intermediate model parameters obtained during the N^{th} training cycle and the historical fused model parameter.

At step 304, respective second fused model parameters of the plurality of sub-processes are obtained when a number of the plurality of sub-processes is the second number, in which the second fused model parameter are obtained by fusing intermediate model parameters from a training cycle N+1 to a training cycle t.

N is a positive integer greater than or equal to 1, and t is a positive integer greater than or equal to 1.

At step 305, fused parameters are obtained by fusing the respective first fused model parameters and the respective second fused model parameters.

In the embodiment of the disclosure, since a total number of the respective first fused model parameters and the respective second fused model parameters is relatively large, in order to facilitate the fusion process of the respective first fused model parameters and the respective second fused model parameters, the respective first fused model parameters, the respective second fused parameter and the fused parameter are all stored in a hard disk during the fusion process.

In the embodiment of the disclosure, the electronic device performs step 305, including: obtaining first combined parameters of the large model by performing a combination process on the respective first fused model parameters; obtaining second combined parameter of the large model by performing a combination process on the respective second fused model parameters; determining a third weight for the first combined parameters based on the N and the t; and obtaining the fused parameters by fusing the first combined parameters and the second combined parameters based on the third weight.

Performing the combination process on the respective first fused model parameters refer to combining parameters of the respective first fused model parameters according to a combination mode for parameters in the large model. Performing the combination process on the respective second fused model parameters refer to combining parameters of the respective second fused model parameters according to a combination mode for parameters in the large model.

The first combined parameters and the second combined parameters may be stored in a hard disk in a format of H5 or the like.

The value of the third weight is mainly influenced by values of N and t. Determining the third weight based on the N and the t can improve the accuracy of determining the third weight. The first combined parameters and the second combined parameters are fused with the third weight, which improves the accuracy of the fused parameters and reduces the influence of the change of the number of sub-processes on model fusion.

In the embodiment of the disclosure, the process of determining the third weight by the electronic device may include: determining a difference between the t and the N; and determining the third weight based on the difference and a second weight for historical fused model parameters in a sub-buffer of the sub-process.

The third weight is a value with the second weight as a base and the difference as an index.

The third weight is a value with the second weight as the base and the difference as the index, which is authenticated through a model fusion authentication process. The authentication process may be, for example, assuming that the intermediate model parameters shown in Equation (1) are generated within a plurality of training cycles during the pre-training process of the large model, where a fault occurs at Mₙ, the training is interrupted, and the fusing sub-buffer is restarted. The equation of the parameter fusion process is shown in Equation (3). Equation (2) indicates that initial model parameters of the large model are all 0.

$$M = \{ {M}_{0} , {M}_{1} , … , {M}_{n} , {M}_{n + 1} , … , {M}_{t} \} \qquad ( 1 )$$

$${M}_{0} = 0 \qquad ( 2 )$$

$${M}_{t}^{′} = α {M}_{t - 1}^{′} + ( 1 - α ) {M}_{t} \qquad ( 3 )$$

where M represents a sequence of intermediate model parameters obtained during the plurality of training cycles; M₀ represents the initial model parameters of the large model; Mₙ represents intermediate model parameters obtained during a training cycle n; Mₜ represents intermediate model parameters obtained during a training cycle t; a represents a weight of historical fused model parameters; (1−a) represents a weight of the intermediate model parameters; and Mₜ′ represents historical fused model parameters after the training cycle t.

The following Equation (4) is obtained by expanding the Equation (3).

$${M}_{t}^{′} = ( 1 - α ) {\sum }_{i = 0}^{f} {α}^{t - i} {M}_{i} \qquad ( 4 )$$

Since the training is interrupted in the training cycle n, two sets of fused model parameters are obtained, in which Mₙ′ represents a first set of fused model parameters, and Mₜ′ represents a second set of fused model parameters.

The equations for calculating the two sets of fused model parameters are shown in the following Equation (5) and Equation (6), respectively.

$${M}_{n}^{′} = ( 1 - α ) {\sum }_{i = 0}^{n} {α}^{n - i} {M}_{i} , EMA ( {M}_{0} , … , {M}_{n} ) \qquad ( 5 )$$

$${M}_{t}^{′} = ( 1 - α ) {\sum }_{j = 1}^{t - n} {α}^{t - n - j} {M}_{n + j} , EMA ( {M}_{0} , {M}_{n + 1} , … , {M}_{t} ) \qquad ( 6 )$$

It can be proved that Mₜ′=α¹⁻ⁿ*Mₙ+Mₜ″, meaning that two sets of fused model parameters can be fused by a weight α^{t-n}.

The portion on the right side of the character “=” in Equation (4) is divided into two parts:

$${M}_{t}^{′} = ( 1 - α ) {\sum }_{i = 0}^{t} {α}^{t - i} {M}_{i} = ( 1 - α ) [ {\sum }_{i = 0}^{n} {α}^{t - i} {M}_{i} + {\sum }_{i = n + 1}^{t} {α}^{t - i} {M}_{i} ] = {M}_{t 1}^{′} + {M}_{t 2}^{′} \qquad ( 7 )$$

$${M}_{t 1}^{′} = ( 1 - α ) {\sum }_{i = 0}^{n} {α}^{t - i} {M}_{i} \qquad ( 8 )$$

$${M}_{t 2}^{′} = ( 1 - α ) {\sum }_{i = n + 1}^{t} {α}^{t - i} {M}_{i} \qquad ( 9 )$$

It is known that Mₜ₁′=α^{t-n}Mₙ′, by bring i=j+n, it is obtained that, Mₜ″=Mₜ₂′,

In conclusion,

$${M}_{t}^{′} = {α}^{t - n} * {M}_{n}^{′} + {M}_{t}^{′} . \qquad ( 10 )$$

The third weight is obtained with the second weight as the base and the difference as the index, and the first combined parameters and the second combined parameters are fused with the third weight, which can further improve the accuracy of the fused parameter.

In the embodiment of the disclosure, after step 305, in order to ensure the accuracy of the fused model parameters in the fusing sub-buffer of each sub-process, the electronic device may distributively store the fused parameters into the fusing sub-buffers of the plurality sub-processes according to the second number of the plurality of sub-processes.

In the embodiment of the disclosure, the electronic device distributively stores the fused parameters into the fusing sub-buffers of the plurality of sub-process, according to the second number of sub-processes, including: for each of the plurality of sub-processes, determining a sequence number of each parameter cached in the fusing sub-buffer of the each of the plurality of sub-processes according to the second number of the plurality of sub-processes; selecting a target fused parameter from the fused parameters according to the sequence number; and storing the target fused parameter into the fusing sub-buffer of the each of the plurality of sub-processes.

In the different fusing sub-buffers of different sub-processes, the fused parameters with different sequence numbers are cached. In the sub-buffers of different sub-processes, the intermediate model parameters with different sequence numbers are cached. According to the sequence numbers, it is convenient to determine which parameter in the fused parameters needs to be stored in the fusing sub-buffer corresponding to which sub-process, thus improving the accuracy of storage of each parameter in the fused parameter.

It should be noted that the details of steps 301-302 can refer to that of steps 101-102 in the embodiment shown in FIG. 1, which will not be described in detail here.

In the model fusion method of the embodiment of the disclosure, the main process is called during the pre-training process of the large model to cache the intermediate model parameters during the pre-training process into the main buffer. The main process calls the sub-process to read the intermediate model parameters from the main buffer and perform the parameter fusion process based on the intermediate model parameters. In a case that the number of sub-processes changes from the first number to the second number, the respective first fused model parameter of the plurality of sub-processes are obtained when the number of the plurality of sub-processes is the first number, in which the maximum value of the sequence numbers of training cycles corresponding to the intermediate model parameters fused in the first fused model parameters is N. The respective second fused model parameters of the plurality of sub-processes are obtained when the number of the plurality of sub-processes is the second number, in which the second fused model parameters are obtained by fusing intermediate model parameters from a training cycle N+1 to a training cycle t. The fused parameter are obtained by fusing the first fused model parameters and the second fused model parameters. In a case that the number of sub-processes changes, the first fused model parameters before the change and the second fused model parameters after the change are fused, which can avoid the interruption of pre-training of the large model and the interruption of model fusion, thus improving the efficiency of the pre-training and the efficiency of model fusion of the large model.

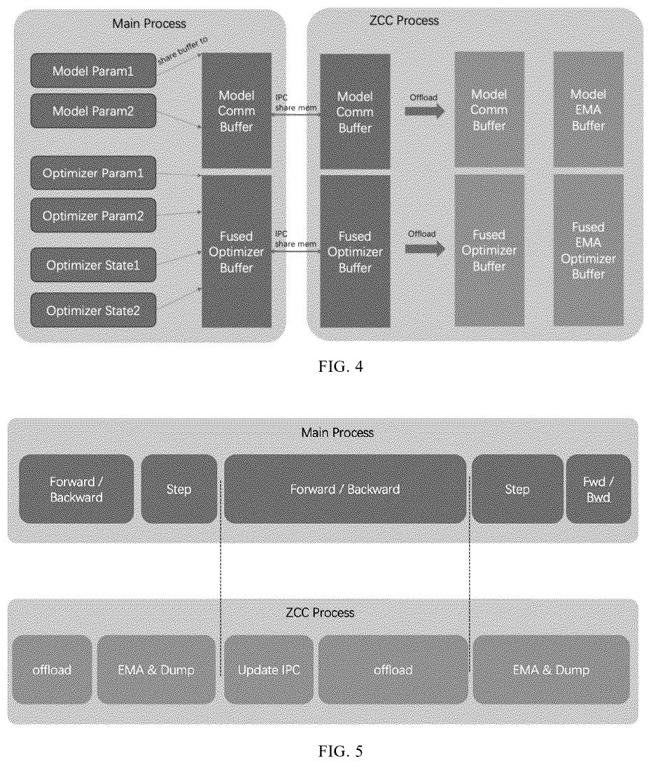

Some examples are provided in the following. As illustrated in FIG. 4, FIG. 4 is a schematic diagram illustrating a framework of a main process and a sub-process. FIG. 4 involves a main process and a corresponding sub-processes. Main Process represents the main process, and ZCC Process represents a sub-process.

Model Param1 and Model Param2 in the Main Process represent intermediate model parameters of floating points with the highest bit, which are stored into the main buffers Model Comm Buff in the Main Process. Optimizer Param1, Optimizer Param2, Optimizer State1 and Optimizer State2 represent intermediate model parameters of floating points with lower bits, which are stored in the main buffer Fused Optimizer Buffer in the Main Process.

In FIG. 4, the dark-gray Model Comm Buff in the Main Process and the dark-gray Model Comm Buff in the ZCC Process represent the same main buffer, and the dark-gray Fused Optimizer Buffer in the Main Process and the dark-gray Fused Optimizer Buffer in the ZCC Process also represent the same main buffer.

In FIG. 4, the light-gray Model Comm Buff in the ZCC Process represents a sub-buffer in the ZCC Process, and the light-gray Fused Optimizer Buffer in the ZCC Process represents another sub-buffer in the ZCC Process.

The ZCC Process can read the intermediate model parameters from the dark-gray Model Comm Buff in the Main Process with the IPC mechanism, and store the read intermediate model parameters into the light-gray Model Comm Buff in the ZCC process. The ZCC Process can read the intermediate model parameters from the dark-gray Fused Optimizer Buffer in the Main Process with the IPC mechanism, and store the read intermediate model parameters into the light-gray Fused Optimizer Buffer in the ZCC Process.

In FIG. 4, the light-gray Model EMA Buffer in the ZCC Process represents a fusing sub-buffer in the ZCC Process, which corresponds to the light-gray Model Comm Buff in the ZCC Process and is used for performing the parameter fusion process based on the intermediate model parameters in the light-gray Model Comm Buff in the ZCC Process, and storing the fused model parameters.

In FIG. 4, the light-gray Fused EMA Optimizer Buffer in the ZCC Process represents another fusing sub-buffer in the ZCC Process, which corresponds to the light-gray Fused Optimizer Buffer in the ZCC Process and is used for performing the parameter fusion process based on the intermediate model parameters in the light-gray Fused Optimizer Buffer in the ZCC Process and storing the fused model parameters.

The dark-gray Model Comm Buff and the dark-gray Fused Optimizer Buffer in the Main Process may be a CUDA memory of a GPU. The light-gray Model Comm Buff and the light-gray Fused Optimizer Buffer in the ZCC Process may be a high-rate memory of a CPU.

Some examples are provided in the following. As illustrated in FIG. 5, FIG. 5 is a schematic diagram illustrating an execution of the main process and the sub-process. FIG. 5 involves a main process and a corresponding sub-process. Forward/Backward represents a training cycle in the pre-training process of the large model, that is, forward propagation/backward propagation in the training cycle. Step indicates to store the intermediate model parameters of which training cycle into the main buffer. Fwd/Bwd is the abbreviation of Forward/Backward.

In FIG. 5, offload indicates that the sub-process reads the intermediate model parameters from the main buffer. Update IPC indicates that the sub-process accesses the main buffer. EMA&Dump indicates reading the intermediate model parameters and performing the parameter fusion process.

In FIG. 5, a duration of a training cycle is greater than or equal to a duration required for the sub-process to read the intermediate model parameters from the main buffer, which is a combination of a duration of Update IPC and a duration of offload.

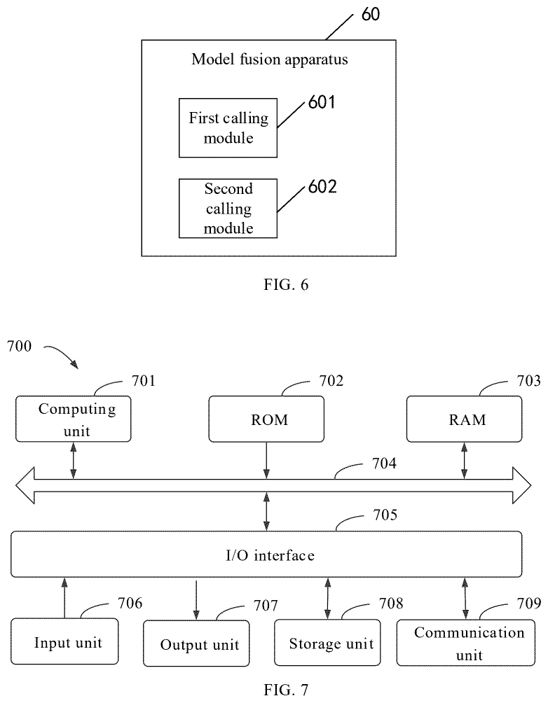

In order to realize the above embodiments, the disclosure also provides a model fusion apparatus. As illustrated in FIG. 6, FIG. 6 is a schematic diagram according to a fourth embodiment of the disclosure. The model fusion apparatus 60 includes: a first calling module 601 and a second calling module 602.

The first calling module 601 is configured to call a main process during a pre-training process of a large model, to cache intermediate model parameters obtained during the pre-training process into a main buffer. The second calling module 602 is configured to call a sub-process via the main process to read the intermediate model parameters from the main buffer and perform a parameter fusion process based on the intermediate model parameters.

In a possible implementation of the embodiment of the disclosure, the main process comprises a plurality of main processes, and the intermediate model parameters stored in the main buffers corresponding to the plurality of main processes respectively are respective parts of model parameters of the large model; and the sub-process comprises a plurality of sub-processes, and the plurality of main processes are in a one-to-one correspondence with the plurality of sub-processes.

In a possible implementation of the embodiment of the disclosure, a condition for calling the sub-process is: each time the large model has completed a pre-training of at least one training cycle and has cached intermediate model parameters obtained during a last training cycle in the at least one training cycle.

In a possible implementation of the embodiment of the disclosure, a number of training cycles in the at least one training cycle is determined based on a sum of a duration required for the sub-process to read the intermediate model parameters and a duration required for performing the parameter fusion process based on the intermediate model parameters.

In a possible implementation of the embodiment of the disclosure, a sum of a duration of a training cycle and a duration of caching the intermediate model parameters into the main buffer is greater than or equal to the duration required for the sub-process to read the intermediate model parameters from the main buffer.

In a possible implementation of the embodiment of the disclosure, the sub-process reads the intermediate model parameters from the main buffer, including: obtaining the intermediate model parameters from the main buffer by accessing the main buffer with an IPC mechanism; and storing the intermediate model parameters into a sub-buffer.

In a possible implementation of the embodiment of the disclosure, the sub-buffer is a high-rate memory in a CPU, and the main buffer is a memory in a GPU.

In a possible implementation of the embodiment of the disclosure, the sub-process performs the parameter fusion process based on the intermediate model parameters, including: reading historical fused model parameters from a fusing sub-buffer, in which the historical fused model parameters are determined by fusing historical intermediate model parameters obtained during at least two training cycles in the pre-training process of the large model; obtaining current fused model parameters by fusing the intermediate model parameters and the historical fused model parameters; and storing the current fused model parameters into the fusing sub-buffer.

In a possible implementation of the embodiment of the disclosure, the sub-process performs the parameter fusion process based on the intermediate model parameters, including: determining a first weight for the intermediate model parameters and a second weight for the historical fused model parameters; and obtaining the current fused model parameters by weighting and summing the intermediate model parameters and the historical fused model parameters based on the first weight and the second weight.

In a possible implementation of the embodiment of the disclosure, the apparatus also includes: a first obtaining module, a second obtaining module and a fusing module. The first obtaining module is configured to, in a case that a number of the plurality of sub-processes changes from a first number to a second number, obtain respective first fused model parameters of the plurality of sub-processes when a number of the plurality of sub-processes is the first number of sub-processes, in which a maximum value of sequence numbers of training cycle corresponding to intermediate model parameters fused in the first fused model parameters is N. The second obtaining module is configured to obtain respective second fused model parameters of the plurality of sub-processes when a number of the plurality of sub-processes is the second number of sub-processes, in which the second fused model parameters are obtained by fusing intermediate model parameters from a training cycle N+1 to a training cycle t. The fusing module is configured to obtain fused parameters by fusing the respective first fused model parameters and the respective second fused model parameters.

In a possible implementation of the embodiment of the disclosure, the fusing module is further configured to: obtain a first combined parameters of the large model by performing a combination process on the respective first fused model parameters; obtain a second combined parameters of the large model by performing a combination process on the respective second fused model parameters; determine a third weight for the first combined parameters according to the N and the t; and obtain the fused parameter by fusing the first combined parameters and the second combined parameters based on the third weight.

In a possible implementation of the embodiment of the disclosure, the fusing module is further configured to: determine a difference between the N and the t; and determine the third weight based on the difference and the second weight for historical fused model parameters in a sub-buffer in the sub-process.

In a possible implementation of the embodiment of the disclosure, the third weight is a value with the second weight as a base and the difference as an index.

In a possible implementation of the embodiment of the disclosure, the apparatus also includes: a storing module, configured to distributively store the fused parameters into fusing sub-buffers of the plurality of sub-processes, according to the second number of the plurality of sub-processes.

In a possible implementation of the embodiment of the disclosure, the storing module is further configured to: for each of the plurality of sub-processes, determine a sequence number of each parameter cached in the fusing sub-buffer of the each of the plurality of sub-processes according to the second number of the plurality of sub-processes; select a target fused parameter from the fused parameters according to the sequence number; and store the target fused parameter into the fusing sub-buffer of each of the plurality of sub-processes.

In a possible implementation of the embodiment of the disclosure, during the parameter fusion process, the first fused model parameters, the second fused model parameters and the fused parameters are stored in a hard disk.

With the model fusion apparatus of the embodiment of the disclosure, the main process is called during the pre-training process of the large model to cache the intermediate model parameters during the pre-training process into the main buffer. The main process calls the sub-process to read the intermediate model parameters from the main buffer and perform the parameter fusion process based on the intermediate model parameters. The main process and the sub-process can be operated asynchronously, and the parameter fusion process can be performed on the intermediate model parameters obtained during the pre-training process of the large model during the pre-training process of the large model, which improves a model fusion efficiency without affecting a pre-training efficiency of the large model.

In the technical solution of the disclosure, collection, storage, usage, processing, transmission, provision and disclosure of personal information of users are all carried out with the consent of users and comply with the provisions of relevant laws and regulations, and do not violate public order and good customs.

According to the embodiments of the disclosure, the disclosure also provides an electronic device, a readable storage medium and a computer program product.

FIG. 7 illustrates a schematic block diagram of an example electronic device 700 that can be used to implement the embodiment of the disclosure. The electronic device is intended to represent various forms of digital computers, such as a laptop computer, a desktop computer, a workbench, a personal digital assistant, a server, a blade server, a mainframe computer and other suitable computers. The electronic device may also represent various forms of mobile devices, such as a personal digital processor, a cellular phone, a smart phone, a wearable device and other similar computing devices. The components shown here, their connections and relations, and their functions are merely exemplary, and are not intended to limit the implementation of the disclosure described and/or required herein.

As illustrated in FIG. 7, the device 700 includes: a computing unit 701 for performing various appropriate actions and processes according to computer programs stored in a read-only memory (ROM) 702 or computer programs loaded from a storage unit 708 to a random access memory (RAM) 703. The RAM 703 may also stores necessary programs and data for the device 700 to operate. The computing unit 701, the ROM 702 and the RAM 703 are connected to each other through a bus 704. An input/output (I/O) interface 705 is also connected to the bus 704.

Components in the device 700 are connected to the I/O interface 705, including: an input unit 706, such as a keyboard and a mouse; an output unit 707, such as various types of displays and speakers; the storage unit 708, such as a disk and an optical disk; and a communication unit 709, such as a network card, a modem and a wireless communication transceiver. The communication unit 709 allows the device 700 to exchange information/data with other devices through a computer network such as the Internet and/or various telecommunication networks.

The computing unit 701 may be various general-purpose and/or dedicated processing components having processing and computing capabilities. Some examples of the computing unit 701 include, but are not limited to, a CPU, a GPU, various dedicated AI computing chips, various computing units that run machine learning (ML) model algorithms, a digital signal processor (DSP) and any appropriate processor, controller or microcontroller. The computing unit 701 executes the various methods and processes described above, such as the model fusion method. For example, in some embodiments, the model fusion method may be implemented as a computer software program, which is tangibly contained in a machine readable medium, such as the storage unit 708. In some embodiments, part or all of the computer programs may be loaded and/or installed on the device 700 via the ROM 702 and/or the communication unit 709. When the computer program is loaded on the RAM 703 and executed by the computing unit 701, one or more steps of the above model fusion method may be executed. Alternatively, in other embodiments, the computing unit 701 may be configured to perform the model fusion method in any other suitable manner (for example, by means of firmware).

Various implementations of the systems and techniques described above may be implemented by a digital electronic circuit system, an integrated circuit system, a field programmable gate array (FPGA), an application specific integrated circuit (ASIC), an application specific standard product (ASSP), a system on chip (SOC), a complex programmable logic device (CPLD), a computer hardware/firmware/software, and/or any combination thereof. These implementations may be implemented in one or more computer programs, the one or more computer programs may be executed and/or interpreted on a programmable system including at least one programmable processor, which may be a dedicated or general programmable processor for receiving data and instructions from a storage system, at least one input device and at least one output device, and transmitting data and instructions to the storage system, the at least one input device and the at least one output device.

The program codes configured to implement the method of the disclosure may be written in any combination of one or more programming languages. These program codes may be provided to a processor/controller of a general-purpose computer, a dedicated computer or any other programmable data processing device, so that when the program code is executed by the processor/controller, the functions/operations specified in the flowchart and/or block diagram can be implemented. The program code may be executed entirely on the machine, or partly executed on the machine, or partly executed on the machine and partly executed on the remote machine as an independent software package or entirely executed on the remote machine or server.

In the context of the disclosure, a machine-readable medium may be a tangible medium that may contain or store a program for use by or in combination with an instruction execution system, an apparatus, or a device. The machine-readable medium may be a machine-readable signal medium or a machine-readable storage medium. The machine-readable medium may include, but is not limited to, an electronic, magnetic, optical, electromagnetic, infrared, or semiconductor system/apparatus/device, or any suitable combination of the above. More specific examples of the machine-readable storage medium include electrical connections based on one or more wires, portable computer disks, hard disks, RAMs, ROMs, electrically programmable ROMs (EPROMs) or flash memories, fiber optics, compact disc ROMs (CD-ROMs), optical storage devices, magnetic storage devices, or any suitable combination of the foregoing.

In order to provide interaction with a user, the systems and techniques described herein may be implemented on a computer having a display device (e.g., a cathode ray tube (CRT) or a liquid crystal display (LCD) monitor) for displaying information to a user; and a keyboard and a pointing device (such as a mouse or a trackball) through which the user can provide input to the computer. Other kinds of devices may also be used to provide interaction with the user. For example, the feedback provided to the user may be any form of sensory feedback (e.g., visual feedback, auditory feedback or haptic feedback), and the input from the user may be received in any form (including acoustic input, voice input or tactile input).

The systems and technologies described herein can be implemented in a computing system that includes back-end components (for example, a data server), or a computing system that includes middleware components (for example, an application server), or a computing system that includes front-end components (for example, a user computer with a graphical user interface or a web browser, through which the user can interact with the implementations of the systems and technologies described herein), or a computing system that includes any combination of such back-end components, middleware components and front-end components. The components of the system may be interconnected by any form or medium of digital data communication (e.g., a communication network). The communication network may include, for example, a local area network (LAN), a wide area network (WAN) and the Internet.

The computer system may include a client and a server. The client and the server are generally remote from each other and interacting through a communication network. The client-server relation is generated by computer programs running on the respective computers and having a client-server relation with each other. The server may be a cloud server, a server with a distributed system, or a server combined with a block-chain.

It is understandable that the steps can be reordered, added or deleted using various forms of the processes shown above. For example, the steps in the disclosure may be performed in parallel, sequentially or in different orders, as long as the desired results of the technical solutions disclosed in the disclosure are achieved, which is not limited herein.

The specific implementations described above do not constitute a limitation on the scope of protection of the disclosure. It should be understood by those skilled in the art that various modifications, combinations, sub-combinations and substitutions can be made depending on the design requirements and other factors. Any modifications, equivalent substitutions and improvements made within the spirit and principles of the disclosure shall be included in the scope of protection of the disclosure.

What is claimed is:

1. A model fusion method, comprising:
calling a main process, during a pre-training process of a large model, to cache intermediate model parameters obtained during the pre-training process into a main buffer; and
calling a sub-process via the main process to read the intermediate model parameters from the main buffer and perform a parameter fusion process based on the intermediate model parameters.

2. The method of claim 1, wherein the main process comprises a plurality of main processes, and intermediate model parameters stored in main buffers corresponding to the plurality of main processes respectively are respective parts of model parameters of the large model; and
the sub-process comprises a plurality of sub-processes, and the plurality of main processes are in a one-to-one correspondence with the plurality of sub-processes.

3. The method of claim 1, wherein a condition for calling the sub-process is: each time the large model has completed a pre-training of at least one training cycle and has cached intermediate model parameters obtained during a last training cycle in the at least one training cycle.

4. The method of claim 3, wherein a number of training cycles in the at least one training cycle is determined based on a sum of a duration required for the sub-process to read the intermediate model parameters and a duration required for performing the parameter fusion process based on the intermediate model parameters.

5. The method of claim 3, wherein a duration of a training cycle is greater than or equal to a duration required for the sub-process to read the intermediate model parameters from the main buffer.

6. The method of claim 1, wherein the sub-process reading the intermediate model parameters from the main buffer comprises:
obtaining the intermediate model parameters from the main buffer by accessing the main buffer with an inter-process communication mechanism; and
storing the intermediate model parameters into a sub-buffer.

7. The method of claim 6, wherein the sub-buffer is a high-rate memory in a central processing unit (CPU); and
the main buffer is a memory in a graphics processing unit (GPU).

8. The method of claim 1, wherein the sub-process performing the parameter fusion process based on the intermediate model parameters comprises:
reading historical fused model parameters from a fusing sub-buffer, wherein the historical fused model parameters are determined by fusing historical intermediate model parameters obtained during at least two training cycles in the pre-training process of the large model;
obtaining current fused model parameters by fusing the intermediate model parameters and the historical fused model parameters; and
storing the current fused model parameters into the fusing sub-buffer.

9. The method of claim 8, wherein obtaining the current fused model parameters by fusing the intermediate model parameters and the historical fused model parameters comprises:
determining a first weight for the intermediate model parameters and a second weight for the historical fused model parameters; and
obtaining the current fused model parameters by weighting and summing the intermediate model parameters and the historical fused model parameters based on the first weight and the second weight.

10. The method of claim 2, further comprising:
in a case that a number of the plurality of sub-processes changes from a first number to a second number, obtaining respective first fused model parameters of the plurality of sub-processes when a number of the plurality of sub-processes is the first number, wherein a maximum value of sequence numbers of training cycles corresponding to intermediate model parameters fused in the first fused model parameters is N;
obtaining respective second fused model parameters of the plurality of sub-processes when a number of the plurality of sub-processes is the second number, wherein the second fused model parameters are obtained by fusing intermediate model parameters from a training cycle N+1 to a training cycle t; and
obtaining fused parameters by fusing the respective first fused model parameters and the respective second fused model parameters.

11. The method of claim 10, wherein fusing the respective first fused model parameters and the respective second fused model parameters comprises:
obtaining first combined parameters of the large model by performing a combination process on the respective first fused model parameters;
obtaining second combined parameters of the large model by performing a combination process on the respective second fused model parameters;
determining a third weight for the first combined parameters based on the N and the t; and
obtaining the fused parameters by fusing the first combined parameters and the second combined parameters based on the third weight.

12. The method of claim 11, wherein determining the third weight for the first combined parameters based on the N and the t, comprises:
determining a difference between the N and the t; and
determining the third weight based on the difference and a second weight for historical fused model parameters in a sub-buffer of the sub-process.

13. The method of claim 12, wherein the third weight is a value with the second weight as a base and the difference as an index.

14. The method of claim 10, further comprising:
distributively storing the fused parameters into fusing sub-buffers of the plurality of sub-processes according to the second number of the plurality of sub-processes.

15. The method of claim 14, wherein distributively storing the fused parameters into the fusing sub-buffers of the plurality of sub-processes according to the second number of the plurality of sub-processes comprises:
for each of the plurality of sub-processes, determining a sequence number of each parameter cached in the fusing sub-buffer of the each of the plurality of sub-processes according to the second number of the plurality of sub-processes;
selecting a target fused parameter from the fused parameters according to the sequence number; and
storing the target fused parameter into the fusing sub-buffer of the each of the plurality of sub-processes.

16. The method of claim 10, wherein during the parameter fusion process, the first fused model parameters, the second fused model parameters and the fused parameters are stored in a hard disk.

17. An electronic device, comprising:
at least one processor; and
a memory communicatively connected to the at least one processor;
wherein the memory stores an instruction executable by the at least one processor, and the instruction, when being executed by the at least one processor, enables the at least one processor to:
call a main process, during a pre-training process of a large model, to cache intermediate model parameters obtained during the pre-training process into a main buffer; and
call a sub-process via the main process to read the intermediate model parameters from the main buffer and perform a parameter fusion process based on the intermediate model parameters.

18. The electronic device of claim 17, wherein the main process comprises a plurality of main processes, and intermediate model parameters stored in main buffers corresponding to the plurality of main processes respectively are respective parts of model parameters of the large model; and
the sub-process comprises a plurality of sub-processes, and the plurality of main processes are in a one-to-one correspondence with the plurality of sub-processes.

19. A non-transitory computer-readable storage medium having a computer instruction stored thereon, wherein the computer instruction is used to cause a computer to implement a method comprising:
calling a main process, during a pre-training process of a large model, to cache intermediate model parameters obtained during the pre-training process into a main buffer; and
calling a sub-process via the main process to read the intermediate model parameters from the main buffer and perform a parameter fusion process based on the intermediate model parameters.

20. A computer program product comprising a computer program, wherein the computer program, when executed by a processor, implements the method of claim 1.
